(19) United States
(12) Patent Application Publication
(10) Pub. No.: US 2014/0274233 A1
(43) Pub. Date: Sep. 18, 2014

(54) Double-Walled Plastic Grain Bin With Integrated Fluid Storage Between Walls

(71) Applicant: AGCO CORPORATION, Duluth, GA (US)

(72) Inventors: Eric Richard Michels, Jackson, MN (US); Bryan S. Claerhout, Hesston, KS (US); Steven R. Tippery, Newton, KS (US); Eric M. Biggs, Hesston, KS (US); Eric M. Reichenberger, Park City, KS (US); Craig C. May, Park City, KS (US)

(73) Assignee: AGCO CORPORATION, Duluth, GA (US)

(21) Appl. No.: 13/832,465

(22) Filed: Mar. 15, 2013

(51) Int. Cl. A01F 12/60

(52) U.S. Cl. CPC A01F 12/60
USPC 460/59

(57) ABSTRACT

In one embodiment, a combine harvester comprising a chassis; and a double-walled, plastic grain storage bin coupled to the chassis, the bin configured to store crop material processed by the combine harvester.

### TECHNICAL FIELD

The present disclosure is generally related to agriculture technology, and, more particularly, grain storage bins for combine harvesters.

### BACKGROUND

Combine harvesters are provided with a processing system comprising a combine core and a cleaning system. The combine core comprises one or more rotors used to thresh and separate grain. Within the cleaning system, oscillating sieve assemblies in conjunction with air flow remove the chaff from the threshed grain, the latter falling through the chaffer and sieve assembly to an oscillating clean grain pan. The clean grain pan, in turn, directs the clean grain to a discharge auger that elevates the grain to an onboard grain storage bin. A second oscillating pan directs materials other than grain over the edge of the bottom sieve assembly to a different discharge outlet for recirculation back through the threshing, separating and cleaning assemblies of the processing system to extract the previously unthreshed grain.

The grain storage bin is generally a welded, bolted, or riveted steel structure coupled to the chassis of the combine harvester and comprises several parts for support and containment of grain.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram that illustrates in a front perspective view an example embodiment of a combine harvester.

FIG. 2 is a schematic diagram that illustrates in a front perspective, fragmentary view an example embodiment of a front portion of a combine harvester with an embodiment of a double-walled, plastic grain storage bin.

FIG. 3 is a schematic diagram that illustrates in a bottom perspective, fragmentary view an example embodiment of a double-walled, plastic grain storage bin.

FIG. 4 is a schematic diagram that illustrates in a top perspective, fragmentary view an example embodiment of a double-walled, plastic grain storage bin.

FIG. 5A is a schematic diagram that illustrates in a top-front perspective view an example embodiment of a double-walled, plastic grain storage bin.

FIG. 5B is a schematic diagram that illustrates in an overhead, plan view an example embodiment of the double-walled, plastic grain storage bin of FIG. 5A.

FIG. 5C is a schematic diagram that illustrates in side elevation, outline view the double-walled, plastic storage bin of FIG. 5A.

### DESCRIPTION OF EXAMPLE EMBODIMENTS

### Overview

In one embodiment, a combine harvester comprising a chassis; and a double-walled, plastic grain storage bin coupled to the chassis, the bin configured to store crop material processed by the combine harvester.

### DETAILED DESCRIPTION

Certain embodiments of a combine harvester having a double-walled, plastic grain storage bin are disclosed that may reduce the quantity of parts and/or weight associated with conventional grain storage bins as well as provide space savings through its inherent fluid storage capabilities. In one embodiment, a combine harvester is disclosed with a double-walled, plastic grain storage bin, where the space between the two walls of the bin may be used for one or more separate fluid storage compartments associated respectively with one or more different fluids.

Digressing briefly, traditional grain storage bins of combine harvesters comprise a welded, bolted, or riveted steel structure comprising several parts for support and containment of grain. Such large assemblies have many parts, and take considerable time to assemble. In addition, combine harvesters have a fuel tank, among other fluid storage compartments. The combination of the conventional grain storage bin and fuel storage occupies a defined area/volume on the combine harvester. In certain embodiments of combine harvesters, the grain storage bin is comprised of a double-walled, plastic material (or blend, such as a blend of polyethylene and nylon), reducing the quantity of sheet-type parts used to contain the crop material (e.g., grain). Also, the space between the two walls of the double-walled grain storage bin may be occupied by one or more separate compartments to store one or more fluids for use by one or more subsystems of the combine harvester, replacing one or more existing storage tanks or containers with a single double-walled grain storage bin.

Having summarized certain features of combine harvesters with double-walled, plastic grain storage bins of the present disclosure, reference will now be made in detail to the description of the disclosure as illustrated in the drawings. While the disclosure will be described in connection with these drawings, there is no intent to limit it to the embodiment or embodiments disclosed herein. For instance, in the description that follows, one focus is on a combine harvester having a transverse-rotor design, though it should be appreciated within the context of the present disclosure that combine harvesters of other designs, such as hybrid, conventional, axial, or dual axial, may be used and hence are contemplated to be within the scope of the present disclosure. Further, although the description identifies or describes specifics of one or more embodiments, such specifics are not necessarily part of every embodiment, nor are all various stated advantages necessarily associated with a single embodiment or all embodiments. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

Note that references hereinafter made to certain directions, such as, for example, “front”, “rear”, “left” and “right”, are made as viewed from the rear of the combine harvester looking forwardly.

Referring now to FIG. 1, shown is an example embodiment of a combine harvester 10 with a double-walled, plastic grain storage bin. It should be understood by one having ordinary skill in the art, in the context of the present disclosure, that the example combine harvester 10 shown in FIG. 1 is merely illustrative, and that other combine configurations may be implemented in some embodiments. The example combine harvester 10 is shown in FIG. 1 without a header, and from front to back, comprises a feeder house 12 and an operator cab 14, followed by a processing system 16 that includes a plurality of components collectively embodied in a combine core (e.g., with threshing and separating functionality) and a cleaning system. In operation, the combine harvester 10 includes a harvesting header at the front of the machine that cuts crop materials and delivers the cut crop materials to the front end of the feeder house 12. Such crop materials are moved upwardly and rearwardly within and beyond the feeder house 12 by a conveyor 18 until reaching a thresher rotor 20 of the processing system 16. The thresher rotor 20 comprises a single, transverse rotor, such as that found in a Gleaner® Super Series Combine by AGCO, though some embodiments may have a dual rotor or axial or hybrid configuration. The thresher rotor 20 processes the crop materials in known manner and passes a portion of the crop material (e.g., heavier chaff, corn stalks, etc.) toward the rear of the combine harvester 10 and another portion (e.g., grain and possibly light chaff) to a cleaning system of the processing system 16 to undergo a cleaning process, as described below. In some embodiments, such as in axial flow designs, the conveyor 18 may convey the cut crop material to a beater before reaching a rotor or rotors.

In the processing system 16, the crop materials undergo threshing and separating operations. In other words, the crop materials are threshed and separated by the thresher rotor 20 operating in cooperation with certain elements of a rotor cage 22, for instance, well-known foraminous processing members in the form of threshing concave assemblies and separator grate assemblies, with the grain (and possibly light chaff) escaping through the concave assemblies and the grate assemblies and onto one or more distribution augers 24 located beneath the processing system 16. Bulkier stalk and leaf materials are generally retained by the concave assemblies and the grate assemblies and are disbursed out from the processing system 16 and ultimately out of the rear of the combine harvester 10. The distribution augers 24 uniformly spread the crop material that falls upon it, with the spread crop material conveyed to accelerator rolls 26. The accelerator rolls 26 speed the descent of the crop material toward a cleaning system 28. Also shown is a transverse, air blowing apparatus 30 (e.g., fan, or equivalently, a blower), which discharges pressurized air through one or more ducts, such as ducts 32 (e.g., which in one embodiment, includes an upper duct and lower duct, as explained below, though not limited to two ducts) to the cleaning system 28 to facilitate the cleaning of the heavier crop material directly beneath the accelerator rolls 26 while causing the chaff to be carried out of the rear of the combine harvester 10. The cleaning system 28 includes plural stacked sieves 34 (e.g., also referred to herein as an oscillating sieve assembly), through which the fan 30 provides an additional push or influence (through a lower duct 32, as explained below) of the chaff flow to the rear of the combine harvester 10.

The cleaned grain that drops to the bottom of the cleaning system 28 is delivered by an auger 36 that transports the grain to a well-known elevator mechanism (not shown, but located on the right hand side of the combine harvester 10), which conveys the grain to a double-walled, plastic grain storage bin 38 located at the top of the combine harvester 10 (shown in FIG. 1 with flaps, though some embodiments may omit the flaps). Any remaining chaff and partially or unthreshed grain is recirculated through the processing system 16 via a tailings return auger 40. Also shown is a pivoting grain unloading spout 42 (shown in the stored position) encompassing an auger 44 that cooperates with a cross auger (not shown, but disposed beneath a portion of the double-walled, plastic grain storage bin 38) to unload the processed grain from the combine harvester 10 to another vehicle. As should be appreciated by one having ordinary skill in the art, the combine harvester 10 also comprises a chassis 46 to which the wheels, drivetrain, steering assemblies, double-walled, plastic grain storage bin 38, cab 14, and processing system 16, among other components, are coupled. As combine processing and its associated components are known to those having ordinary skill in the art, further discussion of the same is omitted here for brevity.

FIG. 2 is a schematic diagram of a front portion of the combine harvester 10 and an embodiment of the double-walled, plastic grain storage bin 38 (also referred to herein as a storage volume). Note that the flaps (e.g., plastic components formed from the plastic molding process to expand the grain storage capacity of the double-walled, plastic grain storage bin 38) of the storage bin 38, among other features not pertinent to the following description and shown in FIG. 1 are omitted here for brevity. In some embodiments, as indicated above, there may be no flaps used in association with the double-walled, plastic grain storage bin 38. The double-walled, plastic grain storage bin 38 (hereinafter, also merely “bin”) is double-walled, plastic, and polygonal in shape to facilitate the deposit and high capacity storage of grain processed by the processing system 16 (FIG. 1). In one embodiment, the bin 38 is formed through a well-known plastic forming/molding process, such as a rotational molding process (also, roto-molding or roto-mold process). In some embodiments, the bin may be formed according to other mechanisms, such as injection or blow molding processes. The bin 38 may be formed according to a plurality of different geometric configurations and/or sizes, with one goal toward achieving a compatible fit to the now-replaced metal grain storage bin (or in some embodiments, occupying a smaller space). In one embodiment, the space between the dual walls of the bin 38 may comprise a single compartment having a defined fluid storage volume for the storage of fluid. The fluid may be a fluid for a given subsystem (e.g., engine/drivetrain, coolant system, catalytic converter, brake system, steering system, etc.) of the combine harvester 10, such as fuel (e.g., diesel), hydraulic fluid, window wash fluid, diesel exhaust fluid (DEF) (e.g., for selective catalytic reduction (SCR) systems), among other fluids that are compatible with plastic materials. In some embodiments, the space between the dual walls of the bin 38 may be occupied by a plurality of compartments, formed in the rotational molding process, for instance, by kiss-offs well-known in plastic molding practice, among other plastic forming methods. In this respect, each compartment that is formed between the dual walls of the bin 38 provides a segregated and sealed compartment for the storage of different fluids. It should be appreciated that in some embodiments, a plurality of the compartments may be used to store the same fluid (e.g., for increased volume capacity). In some embodiments, the space between the two walls may be occupied with an insulating material disposed between adjacent compartments to provide a more manageable control of temperature for the fluid or fluids of those compartments. In the embodiment depicted in FIG. 2, the bin 38 is embodied with a single compartment that includes the entire inner space between the two walls of the bin 38.

The bin 38 is also shown schematically with an inlet port 48 disposed on the top of one (e.g., the rear side, though not limited as such) of the sides of the bin 38. The inlet port 48 is configured to receive the fluid for deposit and storage in the compartment between the two walls. The inlet port 48 may have be an aperture or opening in one or more of the side walls, and in some embodiments, may comprise a hingeably-acting (or screw-type or snap-off or pull-off-type), closeable cover or cap. In some embodiments, the inlet port 48 may include a fixed (or detachable) screen that is used to mitigate the entry of contaminants. In some embodiment, the bin 38 may comprise a plurality of inlet ports of the same or different geometry and/or size than shown in FIG. 2, and similarly may be used to facilitate the deposit of the fluid. Though shown on the top side, external surface of the bin 38, some embodiments may have an inlet port disposed on another exterior surface, such as in an upper portion of a wall (e.g., front, back, and/or side(s)) for instance. As should be appreciated by one having ordinary skill in the art, in the context of the present disclosure, additional inlet ports may be disposed on the bin 38 for respective compartments to receive different fluids, each segregated from one another.

Referring to FIG. 3, shown is a bottom portion of the bin 38 of FIG. 2. The bin 38 comprises, in one embodiment, apertures 50 and 52 disposed on the bottom of the bin 38. Disposed beneath the aperture 50 is a cross auger 54 running transversely in the combine harvester 10. The aperture 50 enables, in one embodiment, an uninterrupted passageway between the interior space of the bin 38 and the cross auger 54. For instance, the cross auger 54 may be housed in a trough (not shown), the trough comprising a metal container with four (4) upright sides that mate with a rectangular portion 56 residing on an underside of the bin 38 and defining a border of the aperture 50. The trough may have an aperture on the left hand side, enabling the cross auger 54 to extend from the interior space of the trough to couple with the auger 44 (FIG. 1) of the unloading spout 42 (FIG. 1). The cross auger 54 conveys the processed crop material or grain (e.g., threshed and separated and cleaned) to the auger 44 of the grain unloading spout 42 for discharge to, for instance, another vehicle. The trough may also serve a function of support for at least a portion of the bin 38. In some embodiments, the lower surface of the bin 38, such as slanted rear wall 58 (a double wall structure), may be extended to a front wall 60 (also double-walled), which serves to encompass the cross auger 54, where an aperture may be disposed on the left hand side of the extended surface for extension of the cross auger 54. With regard to the aperture 52, the processed grain is conveyed to the bin 38 via an elevator mechanism (not shown) that is disposed in aperture 52. In some embodiments, the aperture 52 may be omitted, and the elevator may reside on the side of bin 38, where the grain is deposited from the elevator mechanism and over the top edge and into the bin 38. Although described using augers for grain conveyance, it should be appreciated that in some embodiments, the combine harvester 10 may include additional and/or other conveying apparatuses or mechanisms (e.g., endless belts, slats, etc.).

The bin 38 may include other apertures, such as aperture 62 disposed in front wall 60 for enabling visual monitoring, from the cab 14 (FIG. 1), of the interior space of the bin 38. Also shown is an outlet port 64 (shown schematically) located at a lower portion of the bin 38. A conduit (e.g., hoses, tubing, etc.) from the outlet port to a subsystem is omitted here to avoid obfuscating certain features. In some embodiments, the outlet port 64 may be located elsewhere, and in some embodiments, there may be more than a single outlet port (e.g., in the case of multiple outlets for a single fluid, multiple outlets for respective fluid compartments and fluids, etc.). The outlet port 64 may comprise an opening in the bottom of the bin 38 (or above the bottom in some embodiments), such as the case of fuel that continuously feeds the combine harvester engine with, for instance, the assistance of a pump (and possibly an intermediary reservoir) that controls fluid flow (or other fluid control apparatus, such as a check valve). In some embodiments, the outlet port 64 may be configured for controlled access. For instance, in one embodiment, the outlet port 64 may be configured as a cover or cap with threads that enable the cap to be screwed on and off, or as a hinged cap. In some embodiments, the outlet port 64 may be configured as an aperture fitted with a flow control valve, such as a check valve, among other types of valves.

The outlet port 64 may be always open, manually opened and closed, automatically opened and closed through the use of a servo or other actuator, or semi-automatically opened and close (e.g., based on operational controls (e.g., switches, levers, etc.) in the cab 14 (FIG. 1)). Sensors in the compartment (or in plural compartments in some embodiments) located between the two walls of the bin 38 may detect the levels (and/or pressure) of the fluid, and signal to an operator in the cab 14 that levels are low and in need of replenishment. In some implementations, such as where the combine harvester 10 (FIG. 1) is operating in a storm where visibility from the cab 14 is obscured due to dirty windows, the operator in the cab 14 may signal the need (e.g., via actuation of a switch on the console in the cab 14) for window washing, and responsive to the actuation of the switch, the outlet port 64 may be opened and the fluid discharged for use on the window (e.g., via a pump assist). As another example, in some implementations, a level sensor in a smaller container for the fluid (closer to the cab 14) may signal fluid levels below a threshold, and the signal is received by an actuator associated with the outlet port 64 to open and release a defined quantity of fluid for replenishment (e.g., all without operator intervention). As yet another example, fluid for a hand or eye wash may be discharged from one of the compartments of the bin 38 through manual adjustment of, for instance, a petcock valve coupled to, or serving as, the outlet port 64. These and/or other examples of semi-automated or automated control for other fluids are contemplated to be within the scope of the disclosure.

Referring to FIG. 4, shown is another view (e.g., top perspective view) of the bin 38 of FIG. 2, further revealing certain features of the bin 38. In the embodiment depicted in FIG. 4, the bin 38 comprises plural (e.g., all) sides having a double-walled construction. For instance, the bin 38 comprises opposing, upright dual sidewalls 66A, 66B, the upright front wall 60 with the aperture 62 optionally disposed therein approximately centrally in the transverse direction (though not limited to a centralized location), and the slanted rear wall 58 having a fore-to-aft upward slant. Also shown is the inlet port 48 on a top surface 68 of upright rear wall 70. As best seen in FIG. 4, the grain that is deposited on the cross auger 54 is conveyed to the auger 44 of the grain unloading spout 42.

It should be appreciated that, in the case of a plurality of compartments, one compartment may store a first fluid in the space between the dual walls of the upright and slanted rear walls 70 and 58, respectively, another separate compartment may be disposed in the space between the dual walls of the side wall 66B, enabling the storage of a second fluid. Likewise, another fluid may be stored in the compartment corresponding to the space between the dual walls of the side wall 66B, and yet another fluid may be stored in between the dual walls of the upright front wall 60. The above description is merely illustrative of an example multi-compartment bin 38, whereas compartments may be divided otherwise with fewer or additional compartments in some embodiments, as enabled by the use of kiss-offs or other segregation and/or sealing techniques in the plastic molding (e.g., rotational molding) process.

Attention is now directed to the bin 38 shown in FIGS. 5A-5C, which shows the bin 38 in various views. Referring to FIG. 5A, the bin 38 is shown in perspective, with the inlet port 48 shown schematically on the top surface 68 of the upright rear wall 70 (as one example), and the addition of formations or supports (e.g., ribs) 72 that are vertically-configured and integrally formed (through the plastic molding process) along the interior side of the upright rear wall 70 of the bin 38, among other interior walls (e.g., depicted schematically in FIG. 5A along the interior side of side wall 66B). Though shown vertically, some embodiments may have horizontal formations, or a combination of vertical and horizontal formations in different arrangements than those depicted in FIG. 5A, or none at in some embodiments. In some embodiments, the formations 72 may be disposed on the exterior surfaces of the bin 38 in lieu of, or in addition to, the formations disposed internally. The formations serve to add support to the bin 38.

In FIG. 5B, an overhead plan view of the bin 38 is shown, with the aperture 50 adjacent slanted rear wall 58, the inlet port 48, and the formations 72 along the interior sides of walls 60, 66A, 66B, and 70 depicted.

Taking a perspective along cut-away A-A, and referring to FIG. 5C, shown is a portion of the bin 38, with the sidewall 66B shown with plural formations 72 vertically arranged on the interior surface of the sidewall 66B. The inlet port 48 enables the deposit of a fluid in the space between the dual walls of the upright rear wall 70. Taking the upright rear wall 70 and slanted rear wall 58 as an illustrative example of the double wall feature, the upright rear wall 70 and the slanted rear wall 58 are shown with a first (e.g., top) wall 74 and a second (e.g., bottom) wall 76, which forms a space or compartment 78 there between for the storage of fluid. Although the slanted rear wall 58 is shown as having a wider space than the upright rear wall 70, it should be appreciated that each double wall may be of the same or substantially the same width in some embodiments, and that in some embodiments, a smaller width than shown is contemplated to be within the scope of the disclosure.

In one embodiment, located in the compartment 78, toward the upper end, is a sensor 80. The sensor 80 may be of an immersive sensor type (e.g., in contact with the fluid of the compartment 78), or a non-immersive (e.g., not in contact with the fluid) type. The sensor 80 may be secured to the inlet port 48, or in some embodiments, affixed to the upright rear wall 70. In some embodiments, the sensor may be located elsewhere, and in some embodiments secured according to other well known fastening mechanisms. Also shown in schematic is a flow control apparatus configured, in one embodiment, as a pump 82, though in some embodiments, other types of devices such as a flow control valves, etc. may be used. The pump 82 is coupled to the outlet port 64, enabling the controlled discharge of the fluid stored in the compartment 78 located between the walls 74 and 76 to a subsystem of the combine harvester 10 (FIG. 1). In some embodiments, flow through the outlet port 64 may be uncontrolled, where flow to one or more subsystems may rely merely on gravity feed (e.g., through an open aperture of the outlet port 64). In some embodiments, flow throughput may be controlled (e.g., by an actuator to open and close the outlet port 64), but once open, flow may be controlled or uncontrolled (e.g., gravity feed).

As is clear from the example embodiments described above, certain embodiments of a combine harvester 10 (FIG. 1) with a double-walled plastic grain storage bin 38 (FIG. 1) may enable a reduction in assembly costs and/or quantity of parts associated with conventional metal grain bins, as well as the capability to free up space based on the multiple types of fluid storage that the bin 38 provides in lieu of separate containers that are conventionally present in addition to the bin 38.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

At least the following is claimed:

1. A combine harvester, comprising:
a chassis;
a processing system coupled to the chassis, the processing system comprising threshing, separating and cleaning components; and
a double-walled, plastic grain storage bin coupled to the chassis, the bin configured to store crop material processed by the processing system and store fluid, for use by the combine harvester, in between the dual walls of the bin.

2. The combine harvester of claim 1, further comprising an inlet port disposed on an external surface of the bin to receive the fluid.

3. The combine harvester of claim 1, further comprising a sensor coupled to the bin and used to monitor a level, pressure, or combination of both the pressure and the level of the fluid disposed in between the dual walls of the bin.

4. The combine harvester of claim 1, further comprising one or more outlet ports disposed on an external surface of the bin to enable a flow of the fluid from in between the dual walls of the bin to one or more subsystems of the combine harvester.

5. The combine harvester of claim 4, further comprising a flow control apparatus operatively coupled to the outlet port, the flow control apparatus configured to control the flow of the fluid through the outlet port.

6. The combine harvester of claim 1, wherein the bin is formed according to a rotational molding process.

7. The combine harvester of claim 1, wherein the bin comprises a plurality of separate and sealed compartments in between the dual walls of the bin.

8. The combine harvester of claim 7, wherein a first of the plurality of compartments is configured to receive a first fluid and a second of the plurality of compartments is configured to receive a second fluid different than the first fluid, the first and second fluids isolated from each other.

9. The combine harvester of claim 7, wherein each of the plurality of compartments comprises an inlet port and an outlet port disposed on one or more external surfaces of the bin.

10. The combine harvester of claim 1, wherein the bin comprises plural apertures disposed on the bin.

11. The combine harvester of claim 10, further comprising a conveying apparatus, wherein a first of the apertures is disposed on a bottom portion of the bin and comprises an uninterrupted passageway between an interior volume of the bin and the conveying apparatus.

12. The combine harvester of claim 11, further comprising a second of the apertures that enables a flow of the processed crop material to the bin.

13. A combine harvester, comprising:
a chassis; and
a double-walled, plastic grain storage bin coupled to the chassis, the bin configured to store crop material processed by the combine harvester.

14. The combine harvester of claim 13, further comprising a processing system coupled to the chassis, the processing system comprising a threshing and separating rotor and a cleaning system.

15. The combine harvester of claim 13, further comprising a compartment located between the dual walls of the bin, the compartment comprising an inlet port and a corresponding outlet port disposed on one or more external surfaces of the bin, the compartment configured to store fluid.

16. The combine harvester of claim 15, wherein the fluid is used in a subsystem of the combine harvester.

17. The combine harvester of claim 13, further comprising a plurality compartments located between the dual walls of the bin, each compartment separate and sealed from an adjacent compartment of the plurality of compartments.

18. The combine harvester of claim 17, wherein each of the plurality of compartments comprises an inlet port and an outlet port disposed on one or more external surfaces of the bin.

19. The combine harvester of claim 13, wherein the bin comprises plural apertures disposed on the bin, and a conveying apparatus, wherein a first of the apertures is disposed on a bottom portion of the bin and comprises an uninterrupted passageway between an interior volume of the bin and the conveying apparatus, and a second of the apertures enables a flow of the processed crop material to the bin.

20. A combine harvester, comprising:
a chassis; and
a rotationally-molded, double-walled, plastic grain storage bin coupled to the chassis, the bin comprising a first storage volume that receives and stores crop material processed by the combine harvester and a second storage volume between the dual walls of the bin that receives and stores fluid used by the combine harvester.
